(19) United States
(12) Patent Application Publication
(10) Pub. No.: US 2015/0286698 A1
(43) Pub. Date: Oct. 8, 2015

(54) REACTIVE DIGITAL PERSONAL ASSISTANT

(71) Applicant: Microsoft Corporation, Redmond, WA (US)

(72) Inventors: Ryan P. Gagnier, Burien, WA (US); Sogol Malekzadeh, Sammamish, WA (US); David Gardner, Seattle, WA (US); Talon E. Ireland, Kirkland, WA (US); Lee Dicks Clark, Seattle, WA (US); Robert Howard, Bellevue, WA (US); Matthew S. Mang, Seattle, WA (US)

(73) Assignee: Microsoft Corporation, Redmond, WA (US)

(21) Appl. No.: 14/247,216

(22) Filed: Apr. 7, 2014

(51) Int. Cl. G06F 17/30; G06F 3/0484

(52) U.S. Cl. CPC G06F 17/30595; G06F 17/30864; G06F 3/04842

(57) ABSTRACT

Techniques are described herein that are capable of providing a reactive digital personal assistant. A reactive digital assistant is a digital assistant that is capable of having a reaction. For instance, the reaction may be provided visually and/or audibly. The reaction may be specified by personal assistant logic on a device that provides the digital personal assistant, by an application on the device that communicates with the personal assistant logic, or by a Web service with which the application communicates. The personal assistant logic may retrieve media representation(s) that correspond to the reaction from a store on the device, or the application may retrieve the media representation(s) from the Web service. The personal assistant logic may notify the application of a status of the digital personal assistant once the media representation(s) are retrieved.

### BACKGROUND

It has become relatively common for devices, such as laptop computers, tablet computers, personal digital assistants (PDAs), and cell phones, to have digital personal assistant functionality. A digital personal assistant is a representation of an entity that interacts with a user of a device. For instance, the digital personal assistant may answer questions that are asked by the user or perform tasks based on instructions from the user. One example of a digital personal assistant is Ski®, which was initially developed by Siri, Inc. and has since been further developed and maintained by Apple Inc. A digital personal assistant typically is able to communicate with a user of a device on which the digital personal assistant is provided. However, digital personal assistants often are not configured to express reactions (e.g., emotions). Accordingly, such digital personal assistants typically do not appear to be sentient.

### SUMMARY

Various approaches are described herein for, among other things, providing a reactive digital personal assistant. A reactive digital assistant is a digital assistant that is capable of having a reaction. For instance, the reaction may be provided visually and/or audibly. The reaction may be specified by personal assistant logic on a device that provides the digital personal assistant, by an application on the device that communicates with the personal assistant logic, or by a Web service with which the application communicates. The personal assistant logic may retrieve media representation(s) that correspond to the reaction from a store on the device, or the application may retrieve the media representation(s) from the Web service. The personal assistant logic may notify the application of a status of the digital personal assistant once the media representation(s) are retrieved.

The reaction of the digital personal assistant may be based on any of a variety of factors, including but not limited to a task that is initiated or performed by a user, content (e.g., search results or search suggestions) that is to be presented to the user, a context of the user, a request from an application that specifies the reaction, etc. The reaction of the digital personal assistant may include any of a variety of actions, including but not limited to transforming into a different form (e.g., shape or object), hinting at content that is to be presented to the user, transforming into a control that is usable by the user to complete a task, interacting with objects (e.g., text, icons, widgets, images, etc.) that are presented to the user, speaking with a voice that has specified attribute(s), making a specified sound, etc.

Example devices are described. A first example device includes an application, a store, and personal assistant logic. The application is configured to provide an emotion request that requests for a digital personal assistant to have a designated emotion. The store is configured to store media representations that correspond to emotions. The personal assistant logic is configured to select designated media representation(s) from the media representations in response to the emotion request based on the designated media representation(s) corresponding to the designated emotion. The personal assistant logic is further configured to use the designated media representation(s) to provide the digital personal assistant having the designated emotion.

A second example device includes an application and personal assistant logic. The application is configured to provide a query for content to a Web service via a network. The application is further configured to provide a use request that requests for designated media representation(s) to be used to provide a digital personal assistant in response to receipt of the designated media representation(s) from the Web service via the network. The designated media representation(s) define a reaction to the content. The personal assistant logic is configured to use the designated media representation(s) to provide the digital personal assistant having the reaction to the content in response to receipt of the use request.

A third example device includes an application, a store, personal assistant logic, and a context analyzer. The application is configured to provide a task indicator that specifies a task that is at least initiated by a user with respect to the application. The store is configured to store media representations that correspond to reactions. The personal assistant logic is configured to provide a context request that requests a context of the user in response to receipt of the task indicator. The personal assistant logic is further configured to select designated media representation(s) from the media representations in response to receipt of a context indicator that specifies the context of the user based on a designated reaction that corresponds to the designated media representation(s) being associated with the context of the user and the task. The personal assistant logic is further configured to use the designated media representation(s) to provide a digital personal assistant having the designated reaction to the task. The context analyzer is configured to provide the context indicator in response to receipt of the context request.

Example methods are also described. In a first example method, an emotion request is provided from an application. The emotion request requests for a digital personal assistant to have a designated emotion. Media representations that correspond to emotions are stored. Designated media representation(s) are selected from the media representations in response to the emotion request based on the designated media representation(s) corresponding to the designated emotion. The designated media representation(s) are used to provide the digital personal assistant having the designated emotion.

In a second example method, a query for content is provided by an application to a Web service via a network. A use request is provided by the application in response to receipt of designated media representation(s) from the Web service via the network. The use request requests for the designated media representation(s) to be used to provide a digital personal assistant. The designated media representation(s) define a reaction to the content. The designated media representation(s) are used to provide the digital personal assistant having the reaction to the content in response to receipt of the use request.

In a third example method, a task indicator is provided by an application. The task indicator specifies a task that is at least initiated by a user with respect to the application. Media representations that correspond to reactions are stored. A context request that requests a context of the user is provided in response to receipt of the task indicator. A context indicator that specifies the context of the user is received in response to providing the context request. Designated media representation(s) are selected from the media representations in response to receipt of the context indicator based on a designated reaction that corresponds to the designated media representation(s) being associated with the context of the user and the task. The designated media representation(s) are used to provide a digital personal assistant having the designated reaction to the task.

Example computer program products are also described. A first example computer program product includes a computer-readable medium having computer program logic recorded thereon for enabling a processor-based system to provide a digital personal assistant having emotion. The computer program logic includes a first program logic module, a second program logic module, and a third program logic module. The first program logic module is for enabling the processor-based system to provide an emotion request from an application. The emotion request requests for a digital personal assistant to have a designated emotion. The second program logic module is for enabling the processor-based system to select designated media representation(s) from media representations that correspond to emotions in response to the emotion request based on the designated media representation(s) corresponding to the designated emotion. The third program logic module is for enabling the processor-based system to use the designated media representation(s) to provide the digital personal assistant having the designated emotion.

A second example computer program product includes a computer-readable medium having computer program logic recorded thereon for enabling a processor-based system to provide a digital personal assistant having a reaction to content. The computer program logic includes a first program logic module, a second program logic module, and a third program logic module. The first program logic module is for enabling the processor-based system to provide a query for content from an application to a Web service via a network. The second program logic module is for enabling the processor-based system to provide a use request from the application in response to receipt of designated media representation(s) from the Web service via the network. The use request requests for the designated media representation(s) to be used to provide a digital personal assistant. The designated media representation(s) define the reaction to the content. The third program logic module is for enabling the processor-based system to use the designated media representation(s) to provide the digital personal assistant having the reaction to the content in response to receipt of the use request.

A third example computer program product includes a computer-readable medium having computer program logic recorded thereon for enabling a processor-based system to provide a digital personal assistant having a designated reaction. The computer program logic includes a first program logic module, a second program logic module, a third program logic module, and a fourth program logic module. The first program logic module is for enabling the processor-based system to provide a task indicator from an application. The task indicator specifies a task that is at least initiated by a user with respect to the application. The second program logic module is for enabling the processor-based system to provide a context request that requests a context of the user in response to receipt of the task indicator. The third program logic module is for enabling the processor-based system to select designated media representation(s) from media representations that correspond to reactions in response to receipt of a context indicator that specifies the context of the user based on the designated reaction, which corresponds to the designated media representation(s), being associated with the context of the user and the task. The fourth program logic module is for enabling the processor-based system to use the designated media representation(s) to provide the digital personal assistant having the designated reaction to the task.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example reaction system in accordance with an embodiment.

FIGS. 2, 4, and 6 are block diagrams of example implementations of a device shown in FIG. 1 in accordance with embodiments.

FIG. 3 depicts a flowchart of an example method for providing a digital personal assistant having emotion in accordance with an embodiment.

FIG. 5 depicts a flowchart of an example method for providing a digital personal assistant having a reaction to content in accordance with an embodiment.

FIG. 7 depicts a flowchart of an example method for providing a digital personal assistant having a designated reaction in accordance with an embodiment.

FIG. 8 is a system diagram of an exemplary mobile device in accordance with an embodiment.

FIG. 9 depicts an example computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. INTRODUCTION

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

### II. EXAMPLE EMBODIMENTS

Example embodiments described herein are capable of providing a reactive digital personal assistant. A reactive digital assistant is a digital assistant that is capable of having a reaction. For instance, the reaction may be provided visually and/or audibly. The reaction may include an emotion, though the scope of the example embodiments are not limited in this respect. The reaction may be specified by personal assistant logic on a device that provides the digital personal assistant, by an application on the device that communicates with the personal assistant logic, or by a Web service with which the application communicates. The personal assistant logic may retrieve media representation(s) that correspond to the reaction from a store on the device, or the application may retrieve the media representation(s) from the Web service. The personal assistant logic may notify the application of a status of the digital personal assistant once the media representation(s) are retrieved.

Example techniques described herein have a variety of benefits as compared to conventional techniques for providing a digital personal assistant. For instance, the example techniques may be capable of providing a digital personal assistant that is capable of expressing reactions. Accordingly, the digital personal assistant may appear to be sentient. The example techniques may be capable of providing a more personal experience for a user, as compared to conventional techniques, which may enhance the user's emotional connection with the digital personal assistant.

The reaction of the digital personal assistant may be based on any of a variety of factors, including but not limited to a task (e.g., providing a speech query, listening to a song, etc.) that is initiated or performed by a user, content (e.g., search results or search suggestions) that is to be presented to the user, a context of the user, a request from an application that specifies the reaction, etc. The digital personal assistant may appear to have an understanding of any one or more of such factors. The reaction of the digital personal assistant may include any of a variety of actions, including but not limited to transforming into a different form (e.g., shape or object), hinting at content that is to be presented to the user, transforming into a control that is usable by the user to complete a task, interacting with objects (e.g., text, icons, widgets, images, etc.) that are presented to the user, indicating that the digital personal assistant is thinking (e.g., when the digital personal assistant is unsure what to display or say, such as when Web content is being downloaded or when speech data is being processed), etc.

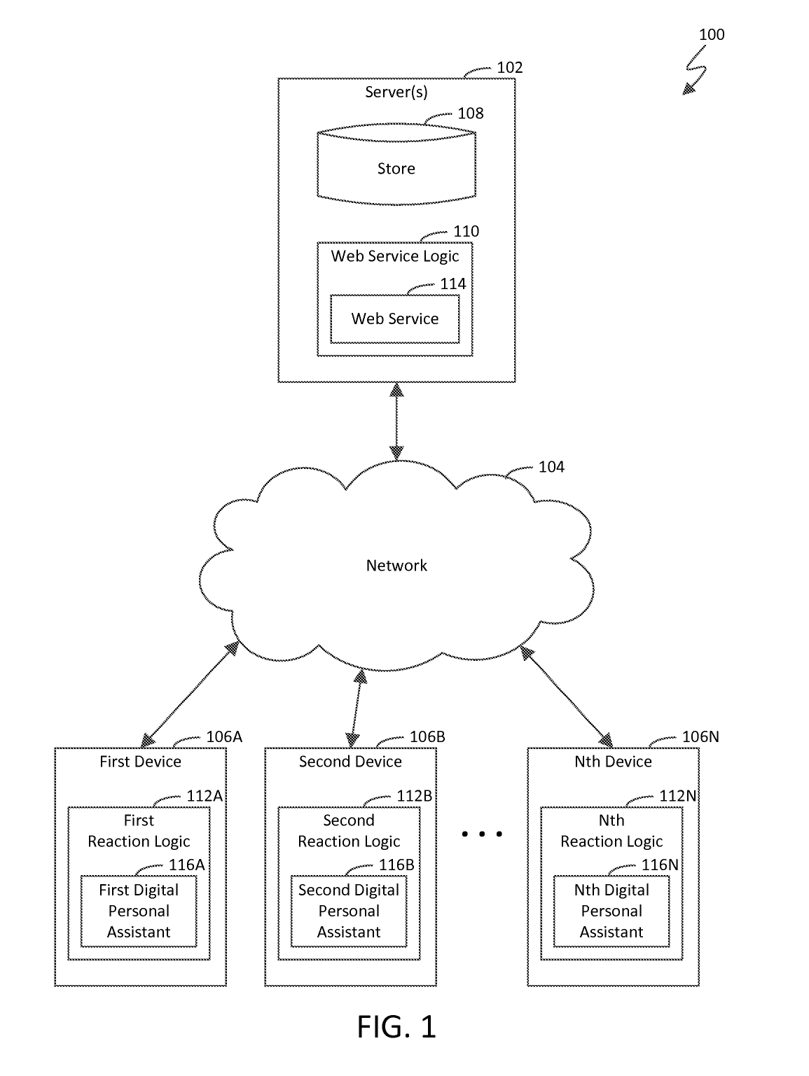

FIG. 1 is a block diagram of an example reaction system 100 in accordance with an embodiment. Generally speaking, reaction system 100 operates to provide information to users in response to requests (e.g., hypertext transfer protocol (HTTP) requests) that are received from the users. The information may include documents (e.g., Web pages, images, audio files, video files, etc.), output of executables, and/or any other suitable type of information. In accordance with example embodiments described herein, reaction system 100 provides reactive digital personal assistant(s). Detail regarding techniques for providing a reactive digital personal assistant is provided in the following discussion.

As shown in FIG. 1, reaction system 100 includes server(s) 102, network 104, and a plurality of devices 106A-106N. Communication among server(s) 102 and devices 106A-106N is carried out over network 104 using well-known network communication protocols. Network 104 may be a wide-area network (e.g., the Internet), a local area network (LAN), another type of network, or a combination thereof.

Devices 106A-106N are processing systems that are capable of communicating with server(s) 102. An example of a processing system is a system that includes at least one processor that is capable of manipulating data in accordance with a set of instructions. For instance, a processing system may be a computer, a personal digital assistant, etc. Devices 106A-106N are configured to provide requests to server(s) 102 for requesting information stored on (or otherwise accessible via) server(s) 102. For instance, a user may initiate a request for executing a computer program (e.g., an application) using a client (e.g., a Web browser, Web crawler, or other type of client) deployed on a device 106 that is owned by or otherwise accessible to the user. In accordance with some example embodiments, devices 106A-106N are capable of accessing domains (e.g., Web sites) hosted by server(s) 102, so that devices 106A-106N may access information that is available via the domains. Such domain may include Web pages, which may be provided as hypertext markup language (HTML) documents and objects (e.g., files) that are linked therein, for example.

It will be recognized that each of devices 106A-106N may include any client-enabled system or device, including but not limited to a desktop computer, a laptop computer, a tablet computer, a wearable computer such as a smart watch or a head-mounted computer, a personal digital assistant, a cellular telephone, or the like.

Devices 106A-106N are shown to include respective reaction logic 112A-112N, which are configured to provide respective digital personal assistants 116A-116N. Each of the devices 106A-106N, each of the reaction logic 112A-112N, and each of digital personal assistants 116A-116N will now be referred to generally as device 106, reaction logic 112, and personal assistant 116, respectively, for ease of discussion. Each reaction logic 112 is configured to provide a respective digital personal assistant 116 that is capable of expressing a reaction. Reaction logic 112 uses media representation(s) to provide the digital personal assistant 116 having the reaction. For instance, the media representation(s) may define the reaction. A media representation includes instructions and/or data that enable the digital personal assistant 116 to have the reaction. Such instructions may define how the media representation is to be used to cause the digital personal assistant 116 to have the reaction.

Each of the media representation(s) may be a visual representation (e.g., an image file) which has a visual component without an audio component, an audio representation (e.g., an audio file) which has an audio component without a visual component, an audio visual representation (e.g., a video file) which has a visual component and an audio component, a haptic representation which has a haptic component, or other suitable representation. It will be recognized that a visual representation, an audio representation, and/or an audio visual representation may include a haptic component, though the scope of the example embodiments is not limited in this respect. Moreover, a haptic representation may include a visual component, an audio component, or audio and visual components, though the scope of the example embodiments is not limited in this respect.

Visual representations and audio visual representations constitute visual content. For instance, visual content may be a static image or a dynamic image. Visual content may be a photograph, a graphical image, a video (e.g., an animation), or other type of media representation that includes instructions and/or data that are usable for generating an image. Audio representations and audio visual representations constitute audio content. For instance, audio content may be an audio clip, a video, or other type of media representation that includes instructions and/or data that are usable for generating sound. Haptic content may be a file or other type of media representation that includes instructions and/or data that are usable for generating a tactile stimulus, including but not limited to a force, vibration, motion, etc.

Reaction logic 112 may directly or indirectly request the media representation(s) from server(s) 102 or retrieve the media representation(s) from a source (e.g., a store) in the device 106. For instance, reaction logic 112 may indirectly request the media representation(s) by providing a query for content to server(s) 102 that causes server(s) 102 to provide the media representation(s) based on the content.

Server(s) 102 are one or more processing systems that are capable of communicating with devices 106A-106N. Server(s) 102 are configured to execute computer programs that provide information to users in response to receiving requests from the users. For example, the information may include documents (e.g., Web pages, images, audio files, video files, etc.), output of executables, or any other suitable type of information. In accordance with some example embodiments, server(s) 102 are configured to host one or more Web sites, so that the Web sites are accessible to users of reaction system 100.

Server(s) 102 are shown to include a store 108 and Web service logic 110. Web service logic 110 is configured to execute a Web service 114 (e.g., Bing® which is developed and maintained by Microsoft Corporation, Google® which is developed and maintained by Google Inc., Yahoo!® which is developed and maintained by Yahoo! Inc., etc.) that is capable of downloading media representation(s) to devices 106A-106N. For example, Web service 114 may receive a request for designated media representation(s) or for a cache of available media representation(s) from a device 106. In accordance with this example, Web service 114 may provide the designated media representation(s) or the cache to the device 106 in response to receipt of the request.

In another example, Web service 114 may receive a query for content from the device 106. In an aspect of this example, Web service 114 may determine a subset of the media representation(s) that corresponds to the content. In accordance with this aspect, Web service 114 may provide the subset to the device 106 in response to receipt of the query. In another aspect, Web service 114 may determine a designated emotion that corresponds to the content. In accordance with this aspect, Web service 114 may provide an indicator that specifies the designated emotion to the device 106 in response to receipt of the query so that the device 106 may determine which of the media representation(s) correspond to the emotion.

Store 108 stores information that is to be downloaded among devices 106A-106N. Such information may include media representations, mappings of contents to emotions and/or to media representations, mappings of emotions to media representations, etc. Store 108 may be any suitable type of store, including but not limited to a database (e.g., a relational database, an entity-relationship database, an object database, an object relational database, an XML database, etc.).

Each of reaction logic 112A-112N may be implemented in various ways to provide a reactive digital personal assistant, including being implemented in hardware, software, firmware, or any combination thereof. For example, each of reaction logic 112A-112N may be implemented as computer program code configured to be executed in one or more processors. In another example, each of reaction logic 112A-112N may be implemented as hardware logic/electrical circuitry. In an embodiment, each of reaction logic 112A-112N may be implemented in a system-on-chip (SoC). Each SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

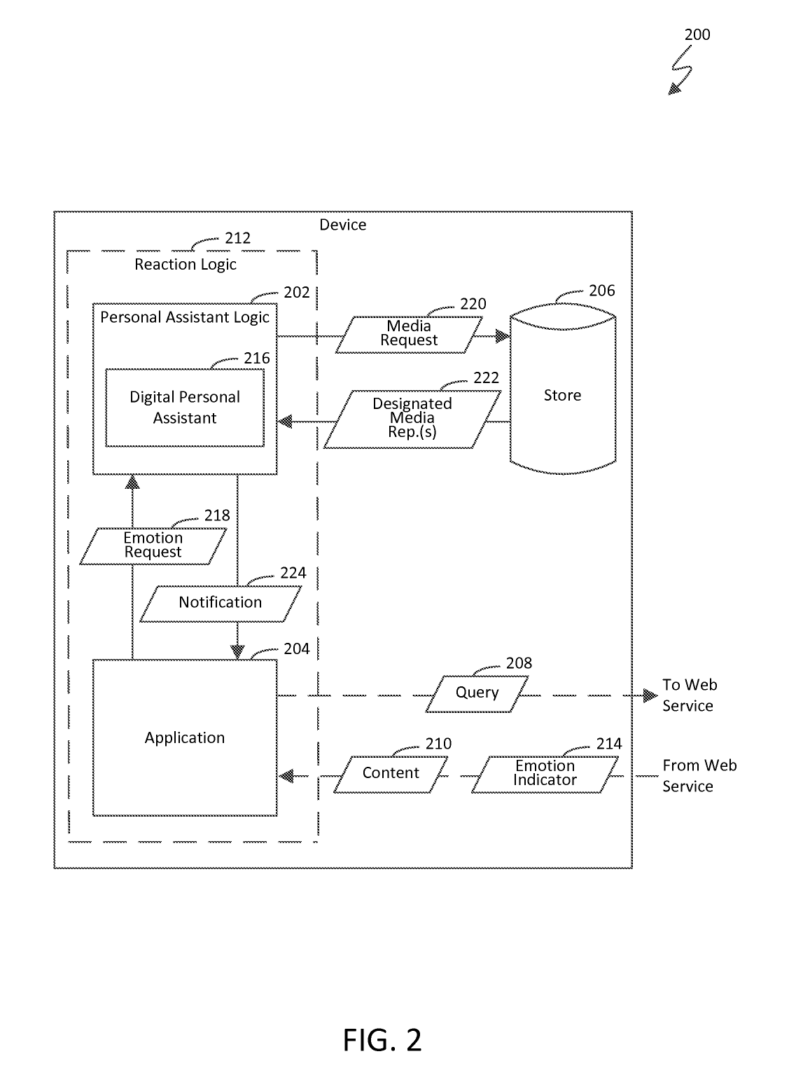

Example techniques for providing a reactive digital personal assistant are discussed in greater detail below with reference to FIGS. 2-7.

FIG. 2 is a block diagram of an example device 200, which is an example implementation of a device 106 shown in FIG. 1, in accordance with an embodiment. For instance, device 200 may be a mobile device (e.g., a personal digital assistant, a cell phone, a tablet computer, a laptop computer, or a wearable computer such as a smart watch or a head-mounted computer), though the scope of the example embodiments is not limited in this respect.

As shown in FIG. 2, device 200 includes reaction logic 212 and store 206. Reaction logic 212 includes personal assistant logic 202 and an application 204. Application 204 is configured to provide an emotion request 218 that requests for a digital personal assistant 216 to have a designated emotion. Application 204 may receive a notification 224 of a status of the digital personal assistant 216 to indicate that the digital personal assistant 216 is configured to have the designated emotion once the digital personal assistant 216 is so configured.

In an example embodiment, application 204 provides a query for content 210 to a Web service (e.g., Web service 114). Application 204 receives the content 210 from the Web service in response to providing the query 208. Application 204 also receives an emotion indicator 214 that specifies the designated emotion from the Web service in response to providing the query 208. The designated emotion, which is specified by the emotion indicator 214, is based on the content 210. In accordance with this embodiment, application 204 provides the emotion request 218 to personal assistant logic 202 in response to receipt of the emotion indicator 214.

Application 204 may be any suitable application including but not limited to a telephone application that is configured to place and/or receive telephone calls, a Web browser, a media player that enables the user to listen to songs and/or to view still images (e.g., photos) and/or videos, a messaging (e.g., email, short message service (SMS), instant message (IM), etc.) application, a word processing application, a graphics editing application, a map application, a social networking application, a calendar application, a clock application, client-side aspects (e.g., interfacing functionality) of a server-hosted application, etc.

Personal assistant logic 202 is configured to select designated media representation(s) 222 from media representations that correspond to emotions in response to the emotion request 218 based on the designated media representation(s) 222 corresponding to the designated emotion. For example, personal assistant logic 202 may provide a media request 220 to store 206, requesting the designated media representation(s) 222. In accordance with this example, personal assistant logic 202 may receive the designated media representation(s) 222 from store 206 in response to providing the media request 220. In another example, personal assistant logic 202 may provide the media request 220 to store 206, requesting a cache of the media representations. The media request 220 may also request a mapping of the emotions to the media representations. In accordance with this example, personal assistant logic 202 may receive the cache of the media representations and/or the mapping from store 206 in response to providing the media request 220. In further accordance with this example, personal assistant logic 202 may select the designated media representation(s) 222 from the media representations (e.g., based on the mapping) in response to receipt of the cache from store 206.

Personal assistant logic 202 is further configured to provide (e.g., host, generate, etc.) the digital personal assistant 216. In accordance with example embodiments, personal assistant logic 202 is configured to use the designated media representation(s) 222 to provide the digital personal assistant 216 having the designated emotion. Personal assistant logic 202 may provide the notification 224 to application 204 in response to configuring the digital personal assistant 216 to have the designated emotion.

Store 206 is configured to store the media representations from which personal assistant logic 202 selects the designated media representation(s) 222. Store 206 is further configured to provide the designated media representation(s) 222 to personal assistant logic 202 in response to receipt of the media request 220.

In some example embodiments, the user may interact with the digital personal assistant 216 using touch commands and/or hover commands. For instance, device 200 may have a touch screen that is configured to detect such touch commands and/or hover commands. A hover command may include a hover gesture. A hover gesture can occur without a user physically touching the touch screen. Instead, the user's hand or portion thereof (e.g., one or more fingers) can be positioned at a spaced distance above the touch screen. The touch screen can detect that the user's hand (or portion thereof) is proximate to the touch screen, such as through capacitive sensing. Additionally, hand movement and/or finger movement can be detected while the hand and/or finger(s) are hovering to expand the existing options for gesture input.

For example, device 200 may be configured to enable the user to play a mini-game with the digital personal assistant 216. In an aspect of this example, the user may be able to tap on the digital personal assistant 216 and drag or chase it around the touch screen and/or interact with other elements on the touch screen. In another example, device 200 may be configured to enable the user to poke the digital personal assistant 216 (e.g., like the Pillsbury Doughboy) to cause the digital personal assistant 216 to react (e.g., laugh, make an expression, etc.). The digital personal assistant 216 may appear to be shy upon initially meeting the user and then gradually become less shy as the user and the digital personal assistant 216 share more interactions.

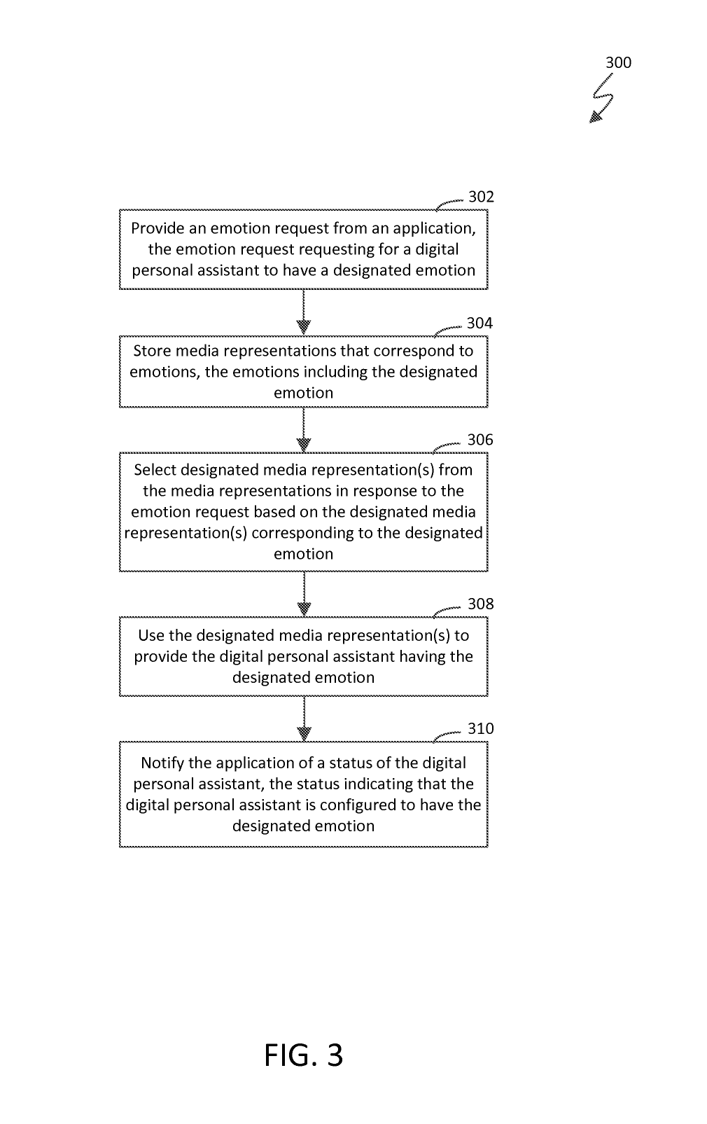

The elements of device 200 will now be described in greater detail with reference to FIG. 3.

FIG. 3 depicts a flowchart 300 of an example method for providing a digital personal assistant having emotion in accordance with an embodiment. For illustrative purposes, flowchart 300 is described with respect to device 200 shown in FIG. 2. Further structural and operational embodiments will be apparent to persons skilled in the relevant art(s) based on the discussion regarding flowchart 300.

As shown in FIG. 3, the method of flowchart 300 begins at step 302. In step 302, an emotion request is provided from an application. The emotion request requests for a digital personal assistant to have (e.g., exhibit) a designated emotion. In an example implementation, application 204 provides emotion request 218 to personal assistant logic 202. In accordance with this implementation, emotion request 218 requests for the digital personal assistant 216 to have the designated emotion.

At step 304, media representations that correspond to emotions are stored. The emotions include the designated emotion. The media representations may be stored based on the media representations having one or more specified attributes, though the scope of the example embodiments is not limited in this respect. For instance, the media representations may be stored based on the media representations corresponding to a specified language, a specified location (e.g., a region in which a user is located), etc. In an example implementation, store 206 stores the media representations.

At step 306, designated media representation(s) are selected from the media representations in response to the emotion request based on the designated media representation(s) corresponding to the designated emotion. The designated media representation(s) may be selected further based on the designated media representation(s) satisfying one or more criteria, including but not limited to the designated media representation(s) corresponding to a specified language, the designated media representation(s) corresponding to a specified location (e.g., a region in which a user is located), etc. The designated media representation(s) may include visual content (e.g., visual representation(s) and/or audio visual representation(s)), audio content (e.g., audio representation(s) and/or audio visual representation(s)), haptic content, or a combination thereof. For instance, the audio content may provide a tone of voice that corresponds to the designated emotion.

In an example implementation, personal assistant logic 202 selects the designated media representation(s) 222 from the media representations that are stored by store 206 in response to the emotion request 218 based on the designated media representation(s) 222 corresponding to the designated emotion. For example, designated emotion information may be associated with the designated emotion. In accordance with this example, personal assistant logic 202 may compare the designated emotion information to instances of media information that are associated with the media representations that are stored by store 206 in order to identify designated media information, which is associated with the designated media representation(s) 222. Each instance of media information is associated with one or more respective media representations that are stored by store 206. For instance, personal assistant logic 202 may identify the designated media information based on how closely the designated media information matches the designated emotion information. In further accordance with this example, personal assistant logic 202 may identify the designated media information based on the designated media information matching the designated emotion information more closely than the other instances of media information match the designated emotion information.

In one aspect of this example, the designated emotion information and the instances of media information may include numerical values. For instance, each numerical value may be associated with a category among a set of categories that correspond to respective emotions. Accordingly, the designated emotion information and the designated media information may include values that are associated with a category that corresponds to the designated emotion. Personal assistant logic 202 may compare the numerical value in the designated emotion information to the numerical values in the respective instances of media information. Personal assistant logic 202 may determine differences between the value in the designated emotion information and the respective values in the instances of media information. Personal assistant logic 202 may identify the designated media information to be the instance of media information that includes the value having a difference from the value in the designated emotion information that is less than the differences between the value in the designated emotion information and the respective values in the other instances of media information. Alternatively, personal assistant logic 202 may identify the designated media information based on differences between the value in the designated emotion information and the respective values in the instances of media information and further based on other factor(s). Examples of other factor(s) include but are not limited to a specified language, a specified location, a mood of the user, etc. For instance, personal assistant logic 202 may determine the mood of the user based on measurement(s) of physiological attribute(s) of the user (e.g., heart rate, blood pressure, extent of perspiration, etc.). Personal assistant logic 202 may then select the designated media representation(s) 222 based on the designated media information.

In another aspect, the designated emotion information and the instances of media information may include keywords. For instance, each keyword may be associated with one or more categories in a set of categories that correspond to respective emotions. Personal assistant logic 202 may compare the keywords in the designated emotion information to the categories to determine which category the designated emotion information most closely matches. Personal assistant logic 202 may compare the keywords in the instances of media information to the categories to determine the category that each instance of media information most closely matches and/or which instance of media information most closely matches each category. Accordingly, personal assistant logic 202 may determine an instance of media information to represent each category. Personal assistant logic 202 may identify the designated media information to be the instance of media information that is determined to represent the category that the designated emotion information most closely matches. Alternatively, personal assistant logic 202 may identify the designated media information based on keyword(s) in the designated media information and further based on other factor(s). Personal assistant logic 202 may then select the designated media representation(s) 222 based on the designated media information.

In an aspect, the designated emotion information may be included in the emotion request 218 that is received by personal assistant logic 202. In another aspect, personal assistant logic 202 may retrieve the designated emotion information from store 206 (e.g., based on an identifier that is included in the emotion request 218).

At step 308, the designated media representation(s) are used to provide the digital personal assistant having the designated emotion. Examples of an emotion include but are not limited to happiness, sadness, calmness, excitement, satisfaction, anger, anxiety, fear, affection, boredom, curiosity, depression, despair, embarrassment, grief, indifference, interest, love, panic, shyness, etc. In an example implementation, personal assistant logic 202 uses the designated media representation(s) 222 to provide the digital personal assistant 216 having the designated emotion. For instance, personal assistant logic 202 may cause the digital personal assistant 216 to have the designated emotion based on the designated media representation(s) 222 (e.g., by executing the designated media representation(s) 222).

At step 310, the application is notified of a status of the digital personal assistant. The status indicates that the digital personal assistant is configured to have the designated emotion. In an example implementation, personal assistant logic 202 provides notification 224 to notify application 204 of the status of the digital personal assistant 216. In accordance with this implementation, the status indicates that the digital personal assistant 216 is configured to have the designated emotion.

In an example embodiment, each of the emotions corresponds to a respective subset of the media representations. Each subset includes multiple media representations that represent multiple versions of the corresponding emotion. In accordance with this embodiment, step 306 includes selecting the designated media representation(s), which correspond to a specified version of the designated emotion, from the subset that corresponds to the designated emotion. For instance, step 306 may further include not selecting other media representations in the subset that corresponds to the designated emotion. In an aspect of this embodiment, the designated media representation(s) may be selected based on an amount of time since the designated media representation(s) are used being greater than an amount of time since each of the other media representations in the subset are used. In another aspect of this embodiment, the multiple versions of an emotion may correspond to multiple respective intensities of the emotion. The multiple intensities may represent statistical variability with regard to the emotion (e.g., a person might not express an emotion in the same way all the time) and/or a context-based, content-based, and/or task-based variability with regard to the corresponding emotion.

In some example embodiments, one or more steps 302, 304, 306, 308, and/or 310 of flowchart 300 may not be performed. Moreover, steps in addition to or in lieu of steps 302, 304, 306, 308, and/or 310 may be performed. For instance, in an example embodiment, the method of flowchart 300 includes selecting the designated emotion from the emotions by the application based on a task (e.g., interaction) that is performed by a user with respect to the application. For example, application 204 may select the designated emotion from the emotions.

Examples of a task include but are not limited to placing and/or receiving a telephone call via a telephone application; requesting and/or consuming (e.g., requesting, viewing, and/or listening to) content via a Web browser; consuming media (e.g., song(s), video(s), still image(s)) via a media player; drafting, sending, viewing, or otherwise interacting with a message via a messaging application; drafting, editing, viewing, or otherwise interacting with a document via a word processing application; drafting, editing, viewing, or otherwise interacting with a document via a graphics editing application; viewing or requesting a map via a map application; drafting, viewing, indicating approval of (e.g., “liking”), or commenting on a social update via a social networking application; setting an appointment or a reminder via a calendar application, setting an alarm via a clock application, providing an instruction for client-side aspects of a server-hosted application to obtain information from server-side aspects of the server-hosted application, etc.

Application 204 may infer (e.g., algorithmically derive) the designated emotion based on the task, though the example embodiments are not limited in this respect. For instance, application 204 may use a neural network to infer the designated emotion. The neural network may employ machine learning and/or pattern recognition techniques to infer the designated emotion. For example, information regarding the user or a group of people that includes the user may be collected, and the designated emotion may be inferred based on such information. In accordance with this example, the information regarding the group of people may be aggregated from information regarding each of the individuals in the group.

For example, application 204 may collect information regarding the user each time the user performs an action with regard to device 200. For instance, reactions of the user to various content and/or tasks may be determined by using a camera to perform facial detection, using sensor(s) to measure physiological attribute(s) of the user, measuring an amount of engagement and/or dwell time the user provides with respect to the content or the digital personal assistant 216, determining a likelihood that the user is to share specified subject matter using social media (such as Facebook® or Twitter®) or a positive statement or a negative statement regarding same, etc. An example of a positive statement is “the Seahawks win”. An example of a negative statement is “the Seahawks lose”. Application 204 may provide the collected information and/or a profile of the user that is based on the collected information to the Web service. Accordingly, the Web service may use the information and/or the profile to determine the designated emotion.

Application 204 may infer the tone (e.g., emotion) of the content 210 to determine the designated emotion. For example, if the content 210 includes a news article, application 204 may infer the tone of the news article to determine how the personal digital assistant 216 is to respond when the content 210 is presented to the user. In accordance with this example, application 204 may apply positive and negative connotations to the words in the news article. Application 204 may derive the tone of the news article based on a combination (e.g., summation) of the positive connotations and the negative connotations. In another example, news articles may be matched to trending topics (e.g., by the Web service). A human curator may determine whether each trending topic is positive or negative, which emotions correspond to each trending topic, etc.

In another example embodiment, the method of flowchart 300 includes providing a query for content (e.g., search results or search suggestions) by the application to a Web service via a network. For instance, application 204 may provide a query 208 for content 210 to the Web service (e.g., Web service 114) via the network (e.g., network 104). In accordance with this embodiment, the method of flowchart 300 includes receiving an emotion indicator that specifies the designated emotion at the application from the Web service via the network. For instance, application 204 may receive emotion indicator 214, which specifies the designated emotion, from the Web service via the network. In further accordance with this embodiment, step 302 includes providing the emotion request in response to receiving the emotion indicator. In further accordance with this embodiment, the designated emotion is based on the content. The designated emotion may be inferred based on the content, though the scope of the example embodiments is not limited in this respect.

In an aspect of this embodiment, the method of flowchart 300 includes using the designated media representation(s) to change a form of the digital personal assistant from a first form to a second form. The second form is based on the content. For instance, application 204 may use the designated media representation(s) 222 to change the form of the digital personal assistant 216.

In one example, the designated media representation(s) may be used to change a shape of the digital personal assistant from a first shape to a second shape, which is based on the content. The first and second shapes may be any suitable respective shapes. Examples of a shape include but are not limited to a circle, an oval, an ellipse, a triangle, a quadrilateral (e.g., square, rectangle, rhombus, trapezoid), a pentagon, a hexagon, an octagon, an irregular shape, etc.

In another example, the designated media representation(s) may be used to transform the digital personal assistant into a control that is usable by the user to perform an operation with respect to the content. For instance, the control may include a soft input panel (SIP) (e.g., a virtual keyboard) to enable the user to provide touch commands and/or hover commands for performing the operation with respect to the content. A SIP is one non-limiting example of a control that enables the user to provide touch commands and/or hover commands. It will be recognized that any suitable control may be used to enable the user to provide touch commands and/or hover commands for performing the operation with respect to the content.

If the content includes a map, the control may enable the user to zoom in and/or zoom out with respect to a location on the map. For instance, the control may include a zoom slider control that enables the user to slide a virtual switch up (or right) to increase magnification with respect to the location and/or to slide the virtual switch down (or left) to decrease magnification with respect to the location. The example directions mentioned above are provided for illustrative purposes and are not intended to be limiting. The zoom slider control may be configured such that the virtual switch may be slid along any suitable axis in any suitable direction to increase or decrease the magnification.

If the content includes media content, such as a song or a video, the control may enable the user to control the media content. For example, the control may include a shuttle control. The shuttle control may enable the user to move the media content frame by frame, control (e.g., set) a rate at which the media content is to be fast forwarded and/or rewound, etc. In another example, the control may include a drag slider control that enables the user to drag a switch along an axis to fast forward and/or rewind to a desired point or frame in the media content. For instance, dragging the switch to the right may fast forward the media content from a point or frame of the media content that is currently playing. Dragging the switch to the left may rewind the media content from a point or frame of the media content that is currently playing. It will be recognized that the drag slider control may be configured such that the switch may be slid along any suitable axis in any suitable direction to fast forward or rewind the media content.

In another aspect of this embodiment, the method of flowchart 300 includes using the designated media representation(s) to cause the digital personal assistant to interact with the content. For instance, application 204 may use the designated media representation(s) 222 to cause the digital personal assistant 216 to interact with the content 210.

Content may include any of a variety of items, including but not limited to text, virtual buttons, widgets, icons, hyperlinks, images, songs, videos, etc. The designated media representation(s) may be used to cause the digital personal assistant to interact with any one or more of such items. For instance, the designated media representation(s) may be used to cause the digital personal assistant to bump, crush, squeeze, kick, throw, swipe, bounce on, jump on or over, go into, come out of, lift, be supported by (e.g., stand on, sit on, lie on, dance on), erase (e.g., partially erase), decorate, take a bite of, throw virtual objects at, dance with, or otherwise interact with the content (e.g., any one or more items therein). For instance, the designated media representation(s) may be used to cause the digital personal assistant to replace an initial version of the content with another version of the content (e.g., including changed text (such as “Michigan won in a barn burner” rather than merely “Michigan won”), coloring, transparency, size, etc.). The digital personal assistant 216 may cause the content to perform actions, including but not limited to performing a flip, flipping upside down, bouncing, wiggling, shaking, floating, exploding, transform into another form, etc.

Although the query for content that is provided by the application to the Web service may not specify advertisement(s), the content may include such advertisement(s). The designated media representation(s) may be used to cause the digital personal assistant to interact with one or more of the advertisement(s). It should be noted that the designated media representation(s) may be used to introduce and/or provide commentary regarding an advertisement in a manner that corresponds to the designated emotion. It should be further noted that the designated media representation(s) may be used to cause the digital personal assistant to interact with one or more items, such as those mentioned above, that are not included in the content.

In yet another aspect of this embodiment, the method of flowchart 300 includes receiving the content at the application from the Web service via the network. For instance, application 204 may receive the content 210 from the Web service. In one scenario of this aspect, the method of flowchart 300 further includes changing an emotion of the digital personal assistant from a first emotion to the designated emotion in response to presentation of the content via a user interface of the device. For instance, personal assistant logic 202 may change the emotion of the digital personal assistant 216 from the first emotion to the designated emotion in response to presentation of the content 210 via a user interface of device 200.

In another scenario of this aspect, the method of flowchart 300 further includes using the designated media representation(s) to cause the digital personal assistant to provide a hint of the content before the content is presented by the device. The hint may include a visual hint (e.g., a visual cue) and/or an audible hint (e.g., an audible cue). A visual hint may be characterized by a designated motion, expression, color, form (e.g., shape), location, etc. of the digital the personal assistant. An audible hint may be characterized by a designated tone of voice, pace of speaking, statement, etc. of the digital personal assistant. For instance, personal assistant logic 202 may use the designated media representation(s) 222 to cause the digital personal assistant 216 to provide a hint of the content 210 before the content 210 is presented by device 200.

In one example, personal assistant logic 202 may use the designated media representation(s) 222 to cause the digital personal assistant 216 to say, “There is something coming up. Do you want additional information?” In another example, personal assistant logic 202 may use the designated media representation(s) 222 to cause the digital personal assistant 216 to bounce on a tile that is displayed on device 200. In accordance with this example, the digital personal assistant 216 bouncing on the tile may indicate that the content 210 is accessible by the user selecting the tile. In yet another example, the content 210 is “below the fold”, meaning that the content 210 is not in view on device 200 but may be brought into view on device 200 by performing a scrolling operation. In an aspect of this example, personal assistant logic 202 may use the designated media representation(s) 222 to cause the digital personal assistant 216 to look down (e.g., toward the content 210 in a non-visible area below the fold). In another aspect of this example, personal assistant logic 202 may cause the screen to scroll a relatively small amount (e.g., one scroll increment) to indicate that the content 210 is below the fold.

It will be recognized that device 200 may not include all of the components shown in FIG. 2. For instance, device 200 may not include one or more of personal assistant logic 202, application 204, and/or store 206. Furthermore, device 200 may include components in addition to or in lieu of personal assistant logic 202, application 204, and/or store 206.

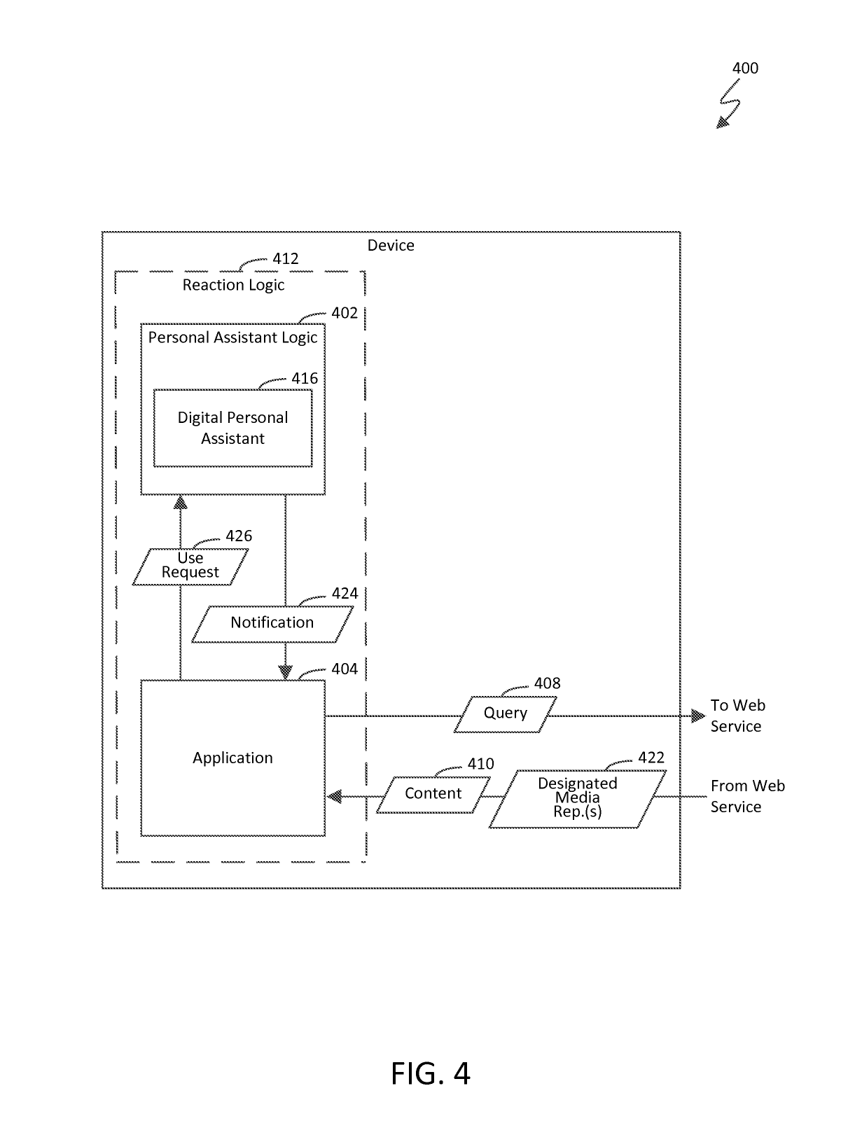

FIG. 4 is a block diagram of an example device 400, which is another example implementation of a device 106 shown in FIG. 1, in accordance with an embodiment. For instance, device 400 may be a mobile device (e.g., a personal digital assistant, a cell phone, a tablet computer, a laptop computer, or a wearable computer such as a smart watch or a head-mounted computer), though the scope of the example embodiments is not limited in this respect.

As shown in FIG. 4, device 400 includes reaction logic 412. Reaction logic 412 includes personal assistant logic 402 and an application 404. Application 404 is configured to provide a query 408 for content 410 to a Web service. Application 404 may receive the content 410 from the Web service in response to providing the query 408. Application 404 may also receive designated media representation(s) 422 from the Web service in response to providing the query 408. The designated media representation(s) 422 define a reaction to the content 410. Application 404 is further configured to provide a use request 246 that requests for the designated media representation(s) 422 to be used to provide a digital personal assistant 416 in response to receipt of the designated media representation(s) 422 from the Web service. Application 404 may receive a notification 424 of a status of the digital personal assistant 416 to indicate that the digital personal assistant 416 is configured to have the reaction once the digital personal assistant 416 is so configured.

Personal assistant logic 402 is configured to use the designated media representation(s) 422 to provide the digital personal assistant 416 having the reaction to the content 410 in response to receipt of the use request 426. Personal assistant logic 402 may provide the notification 424 to application 404 in response to configuring the digital personal assistant 416 to have the reaction, which is defined by the designated media representation(s) 422.

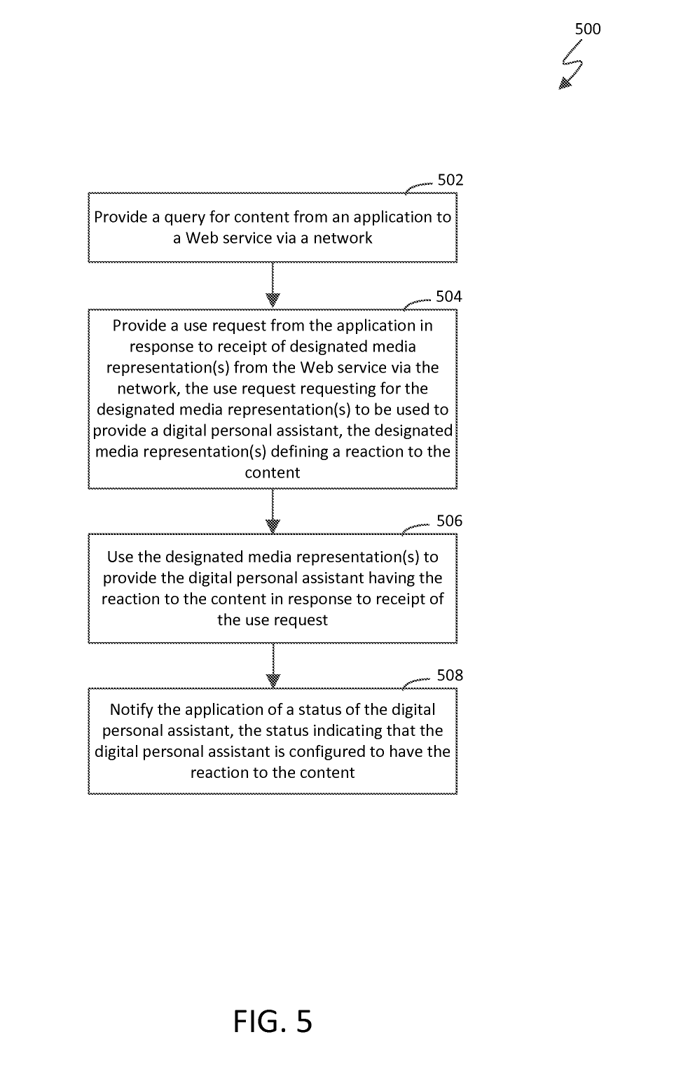

The elements of device 400 will now be described in greater detail with reference to FIG. 5.

FIG. 5 depicts a flowchart 500 of an example method for providing a digital personal assistant having a reaction to content in accordance with an embodiment. For illustrative purposes, flowchart 500 is described with respect to device 400 shown in FIG. 4. Further structural and operational embodiments will be apparent to persons skilled in the relevant art(s) based on the discussion regarding flowchart 500.

As shown in FIG. 5, the method of flowchart 500 begins at step 502. In step 502, a query for content (e.g., search results and/or search suggestions) is provided from an application to a Web service via a network. In an example implementation, application 404 provides query 408 for content 410 to the Web service (e.g., Web service 114) via the network (e.g., network 104).

At step 504, a use request is provided from the application in response to receipt of designated media representation(s) from the Web service via the network. The use request requests for the designated media representation(s) to be used to provide a digital personal assistant. The designated media representation(s) define a reaction to the content. In an example implementation, application 404 provides use request 426 to personal assistant logic 402 in response to receipt of designated media representation(s) 422 from the Web service via the network. The use request 426 requests for the designated media representation(s) 422 to be used to provide a digital personal assistant 416.

At step 506, the designated media representation(s) are used to provide the digital personal assistant having the reaction to the content in response to receipt of the use request. In an example implementation, personal assistant logic 402 uses the designated media representation(s) 422 to provide the digital personal assistant 416 having the reaction to the content 410 in response to receipt of the use request 426 from application 404. For instance, personal assistant logic 402 may cause the digital personal assistant 416 to have the reaction based on the designated media representation(s) 222 (e.g., by executing the designated media representation(s) 222).

In an example embodiment, step 506 includes using the designated media representation(s) to change a form of the digital personal assistant from a first form to a second form. In accordance with this embodiment, the second form is based on the content. For instance, personal assistant logic 402 may use the designated media representation(s) 422 to change a form of the digital personal assistant 416 from a first form to a second form, which is based on the content 410. For example, if the content 410 indicates that rain is forecasted for the day, the digital personal assistant 416 may transform into a rain cloud. In another example, if the content 410 includes information regarding an airline flight, the digital personal assistant 416 may transform into an airplane. In yet another example, if the content 410 is travel suggestions, the digital personal assistant 416 may transform into a globe or a map. If the content includes information regarding a package delivery, the digital personal assistant 416 may transform into a package. These examples are provided for illustrative purposes and are not intended to be limiting. It will be recognized that the digital personal assistant 416 may change to any suitable form.

In another example embodiment, step 506 includes using the designated media representation(s) to cause the digital personal assistant to interact with the content. For instance, personal assistant logic 402 may use the designated media representation(s) 422 to cause the digital personal assistant 416 to interact with the content 410.

At step 508, the application is notified of a status of the digital personal assistant. The status indicates that the digital personal assistant is configured to have the reaction to the content. In an example implementation, personal assistant logic 402 provides notification 424 to application 404 to notify application 404 of the status of the digital personal assistant 416. In accordance with this implementation, the status indicates that the digital personal assistant 416 is configured to have the reaction to the content 410.

In some example embodiments, one or more steps 502, 504, 506, and/or 508 of flowchart 500 may not be performed. Moreover, steps in addition to or in lieu of steps 502, 504, 506, and/or 508 may be performed. For instance, in an example embodiment, the method of flowchart 500 includes receiving the content at the application from the Web service via the network. For example, application 404 may receive the content 410 from the Web service via the network. In accordance with this embodiment, the method of flowchart 500 includes stopping use of first media representation(s) to provide the digital personal assistant and starting use of the designated media representation(s) to provide the digital personal assistant having the reaction to the content in response to presentation of the content via a user interface of the device. For instance, personal assistant logic 402 may stop the use of the first media representation(s) to provide the digital personal assistant 416 and start the use of the designated media representation(s) 422 to provide the digital personal assistant 416 having the reaction to the content 410 in response to presentation of the content 410 via a user interface of device 400.

In another example embodiment, the method of flowchart 500 includes receiving the content at the application from the Web service via the network. For instance, application 404 may receive the content 410 from the Web service via the network. In accordance with this embodiment, step 506 includes using the designated media representation(s) to cause the digital personal assistant to provide a hint of the content before the content is presented by the device. The hint may include a visual hint (e.g., a visual cue) and/or an audible hint (e.g., an audible cue). For instance, personal assistant logic 402 may use the designated media representation(s) 422 to cause the digital personal assistant 416 to provide the hint of the content 410 before the content 410 is presented by device 400.

It will be recognized that device 400 may not include all of the components shown in FIG. 4. For instance, device 400 may not include one or more of personal assistant logic 402 and/or application 404. Furthermore, device 400 may include components in addition to or in lieu of personal assistant logic 402 and/or application 404.

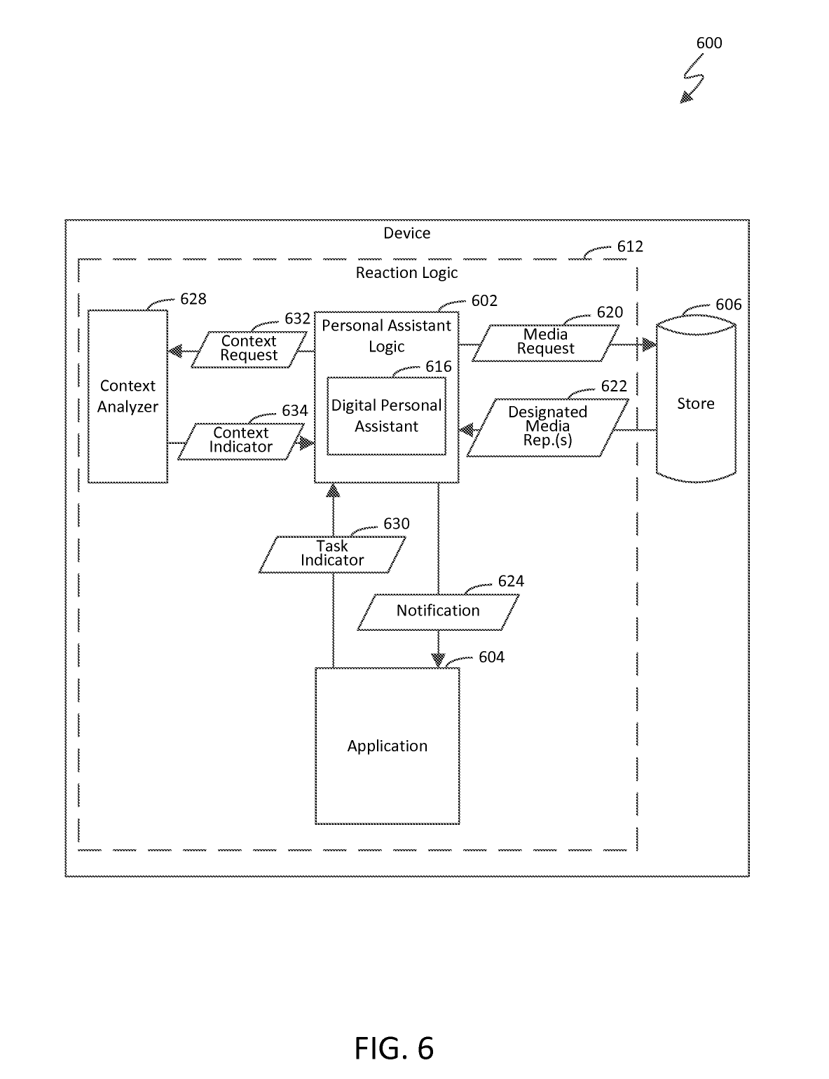

FIG. 6 is a block diagram of an example device 600, which is another example implementation of a device 106 shown in FIG. 1, in accordance with an embodiment. For instance, device 600 may be a mobile device (e.g., a personal digital assistant, a cell phone, a tablet computer, a laptop computer, or a wearable computer such as a smart watch or a head-mounted computer), though the scope of the example embodiments is not limited in this respect.

As shown in FIG. 6, device 600 includes reaction logic 612 and store 606. Reaction logic 612 includes personal assistant logic 602, an application 604, and a context analyzer 628. Application 604 is configured to provide a task indicator 630 that specifies a task that is at least initiated by a user with respect to application 604. For instance, the task indicator 630 may indicate that the task is initiated by the user or that the task is performed by the user.

Application 604 may receive a notification 624 of a status of a digital personal assistant 616 to indicate that the digital personal assistant 616 is configured to have a designated reaction to the task once the digital personal assistant 616 is so configured.

Personal assistant logic 602 is configured to provide a context request 632 that requests a context of the user in response to receipt of the task indicator 630. Personal assistant logic 602 may receive a context indicator 634 that specifies the context of the user in response to providing the context request 632. The context of the user may include an emotional state of the user, preference(s) of the user (e.g., an interest in a specified subject matter or a dislike of a specified subject matter), physiological attribute(s) (e.g., heart rate, blood pressure, extent of perspiration, etc.) of the user, etc. The context may indicate that the user is asking a question, providing a command, etc.

Personal assistant logic 602 is further configured to determine the designated reaction, which digital personal assistant 616 is to have to the task, based on the context of the user and the task. For instance, the designated reaction to the task may include having (e.g., exhibiting) a designated emotion that is based on the task. For example, personal assistant logic 602 may select the designated reaction (e.g., including the designated emotion) to mirror a current emotion of the user and/or an emotion that the user is likely to have to the task. It can be said that personal assistant logic 602 is configured to associate the designated reaction with the context of the user and the task. Personal assistant logic 602 may infer the designated reaction based on the context of the user and the task, though the scope of the example embodiments is not limited in this respect.

Personal assistant logic 602 is further configured to select designated media representation(s) 622 that correspond to the designated reaction from media representations that correspond to reactions in response to receipt of the context indicator 634 based on the designated reaction being associated with the context of the user and the task. For instance, personal assistant logic 602 may provide a media request 620 to store 606, requesting the designated media representation(s) 622. Personal assistant logic 602 may receive the designated media representation(s) 622 in response to providing the media request 620.

Personal assistant logic 602 is further configured to use the designated media representation(s) 622 to provide the digital personal assistant 616 having the designated reaction to the task. Personal assistant logic 602 may provide the notification 624 to application 604 in response to configuring the digital personal assistant 616 to have the designated reaction.

In one example, if the task includes inquiring about the weather, a blizzard is forecasted, and the user's context indicates that the user likes cold weather, personal assistant logic 602 may use the designated media representation(s) 622 to cause the digital personal assistant 616 to appear happy or excited, to dance in snow, to make snow angels, etc. For instance, context analyzer 628 may infer that the user likes cold weather based on knowledge of past activities of the user (e.g., knowledge that the user goes snow skiing relatively frequently). On the other hand, if the user's context indicates that the user dislikes cold weather, personal assistant logic 602 may use the designated media representation(s) 622 to cause the digital personal assistant 616 to appear unhappy or frightened, to shiver, etc.

In another example, if the task includes requesting a score of a Seahawks game, the Seahawks won the game, and the user's context indicates that the user is a Seahawks fan, personal assistant logic 602 may use the designated media representation(s) 622 to cause the digital personal assistant 616 to appear happy, to crush the opposing team's name and/or score, to dance, to turn into a fireworks display, etc. On the other hand, if the user's context indicates that the user is a fan of the opposing team or dislikes the Seahawks, personal assistant logic 602 may use the designated media representation(s) 622 to cause the digital personal assistant 616 to appear unhappy, to deflate, etc.

Context analyzer 628 is configured to determine the context of the user. For example, context analyzer 628 may determine (e.g., interpret) how the user is currently feeling (e.g., using information regarding physiological attribute(s) of the user and/or other information) and/or how the user is likely to feel based on the task (e.g., using biometrics, facial detection via a camera of device 600, etc.). For instance, context analyzer 628 may receive the physiological information and/or the biometrics from a system or device that is external to device 600. In accordance with this example, context analyzer 628 may determine the context of the user to indicate how the user is currently feeling and/or how the user is likely to feel based on the task. In another example, the context of the user may be changeable by the user. For instance, context analyzer 628 may provide a user interface that enables the user to change the context of the user. In yet another example, the context of the user is not changeable by the user. Context analyzer 628 is further configured to provide the context indicator 634, which specifies the context of the user, in response to receipt of the context request 632.

Store 606 is configured to store the media representations from which personal assistant logic 602 selects the designated media representation(s) 622. Store 606 is further configured to provide the designated media representation(s) 622 to personal assistant logic 602 in response to receipt of the media request 620.

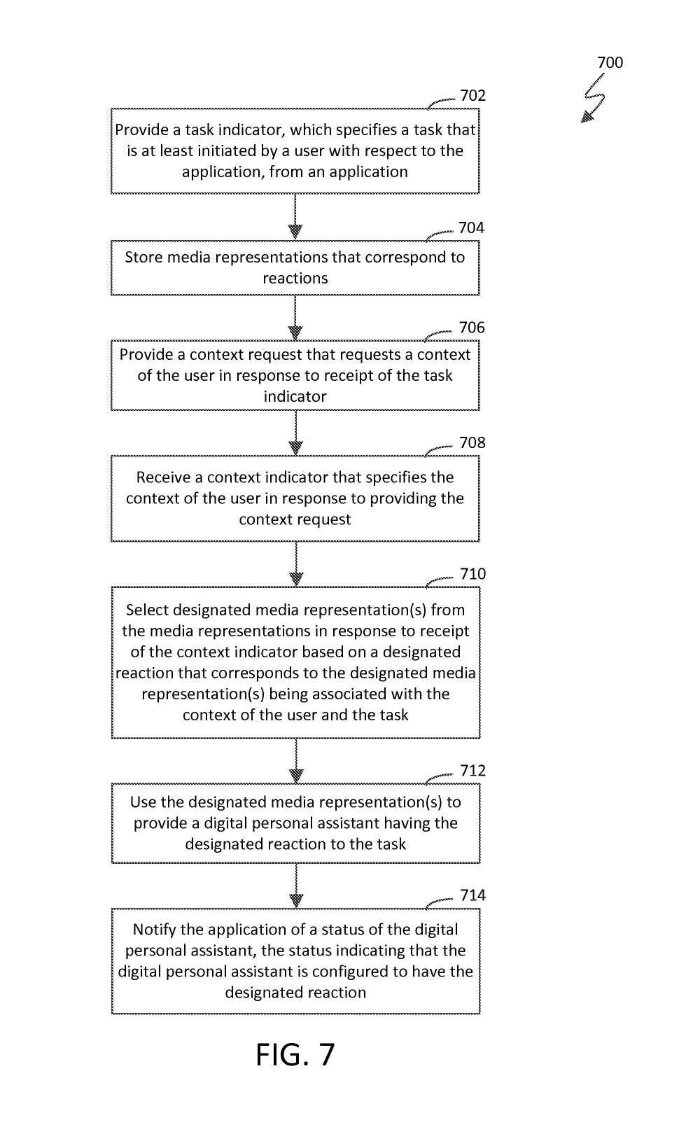

The elements of device 600 will now be described in greater detail with reference to FIG. 7.

FIG. 7 depicts a flowchart 700 of an example method for providing a digital personal assistant having a designated reaction in accordance with an embodiment. For illustrative purposes, flowchart 700 is described with respect to device 600 shown in FIG. 6. Further structural and operational embodiments will be apparent to persons skilled in the relevant art(s) based on the discussion regarding flowchart 700.

As shown in FIG. 7, the method of flowchart 700 begins at step 702. In step 702, a task indicator is provided from an application. The task indicator specifies a task that is at least initiated by a user with respect to the application. In an example implementation, application 604 provides the task indicator 630 to personal assistant logic 602. For instance, application 604 may detect that the task is initiated or that the task is completed. Application 604 may provide the task indicator in response to determining that the task is initiated or that the task is completed.

At step 704, media representations that correspond to reactions are stored. In an example implementation, store 606 stores the media representations.

At step 706, a context request that requests a context of the user is provided in response to receipt of the task indicator. In an example implementation, personal assistant logic 602 provides the context request 632 to context analyzer 628 in response to receipt of the task indicator 630 from application 604.

At step 708, a context indicator that specifies the context of the user is received in response to providing the context request. For instance, the context of the user may include an emotional state of the user. In an example implementation, personal assistant logic 602 receives the context indicator 634 from context analyzer 628 in response to providing the context request 632.

At step 710, designated media representation(s) are selected from the media representations in response to receipt of the context indicator based on a designated reaction that corresponds to the designated media representation(s) being associated with the context of the user and the task. For instance, the designated reaction may include a designated emotion that is based on the context of the user and the task. In an example implementation, personal assistant logic 602 selects the designated media representation(s) 622 from the media representations in response to receipt of the context indicator 634 from context analyzer 628 based on the designated reaction being associated with the context of the user and the task. Personal assistant logic 602 may infer the designated reaction based on the context of the user and the task, though the scope of the example embodiments is not limited in this respect.

In one example, context information may be associated with the context of the user. Task information may be associated with the task. Instances of media information may be associated with the media representations that are stored by store 606. Each instance of media information is associated with one or more respective media representations that are stored by store 606. In accordance with this example, personal assistant logic 602 may compare the context information and the task information to the instances of media information in order to identify designated media information, which is associated with the designated media representation(s) 622. For instance, personal assistant logic 602 may identify the designated media information based on how closely the designated media information matches the context information and the task information. In further accordance with this example, personal assistant logic 602 may identify the designated media information based on the designated media information matching the context information and the task information more closely than the other instances of media information match the context information and the task information.

In one aspect of this example, the context information, the task information, and the instances of media information may include numerical values. For instance, each numerical value may be associated with a category among a set of categories that correspond to respective reactions. Accordingly, the context information, the task information, and the designated media information may include values that are associated with a category that corresponds to the designated reaction. Personal assistant logic 602 may compare the numerical values in the context information and the task information to the numerical values in the respective instances of media information. Personal assistant logic 602 may determine differences between the values in the context information and the respective values in the instances of media information. Personal assistant logic 602 may further determine differences between the values in the task information and the respective values in the instances of media information. Personal assistant logic 602 may identify the designated media information to be the instance of media information that includes the value having a cumulative difference, which is a combination (e.g., sum) of the differences from the values in the context information and task information, that is less than the cumulative differences for the values in the other instances of media information. Personal assistant logic 602 may then select the designated media representation(s) 622 based on the designated media information.

It will be recognized that the context information and the task information may be combined to provide combined information, which includes a numerical value that represents a combination of the context and the task. It will be further recognized that the numerical value in the combined information may be compared to the numerical values in the respective instances of media information, rather than comparing the numerical values in the context information and the task information to the numerical values in the respective instances of media information, in order to identify the designated media information.

In another aspect, the context information, the task information, and the instances of media information may include keywords. For instance, each keyword may be associated with one or more categories in a set of categories that correspond to respective reactions. Personal assistant logic 602 may compare the keywords in the context information and the task information to the categories to determine which category the combination of the context information and the task information most closely matches. Personal assistant logic 602 may compare the keywords in the instances of media information to the categories to determine the category that each instance of media information most closely matches and/or which instance of media information most closely matches each category. Accordingly, personal assistant logic 602 may determine an instance of media information to represent each category. Personal assistant logic 602 may identify the designated media information to be the instance of media information that is determined to represent the category that the combination of the context information and the task information most closely matches. Personal assistant logic 602 may then select the designated media representation(s) 622 based on the designated media information

At step 712, the designated media representation(s) are used to provide a digital personal assistant having (e.g., exhibiting) the designated reaction to the task. In an example implementation, personal assistant logic 602 uses the designated media representation(s) 622 to provide the digital personal assistant 616 having the designated reaction to the task.

In an example embodiment, step 712 may include using the designated media representation(s) to transform the digital personal assistant into a control that is usable by the user to complete the task. Examples of a control include but are not limited to a virtual keypad that enables the user to place a telephone call or to set a time for an alarm; a selectable virtual element (e.g., icon) that enables the user to accept a telephone call; a text window and/or SIP that enables the user to enter search terms in a Web browser, draft, edit, or otherwise interact with a document, a message, or a social update, or set a time or draft a caption for an appointment, a reminder thereof, or an alarm; a shuttle control or a drag slider control that enables the user to control media (e.g., song(s), video(s), still image(s)); a zoom slider control that enables the user to control magnification with respect to a location on a map, etc.

At step 714, the application is notified of a status of the digital personal assistant. The status indicates that the digital personal assistant is configured to have the designated reaction. In an example implementation, personal assistant logic 602 notifies application 604 of a status of the digital personal assistant 616. In accordance with this implementation, the status indicates that the digital personal assistant 616 is configured to have the designated reaction.

In some example embodiments, one or more steps 702, 704, 706, 708, 710, 712, and/or 714 of flowchart 700 may not be performed. Moreover, steps in addition to or in lieu of steps 702, 704, 706, 708, 710, 712, and/or 714 may be performed. For instance, in an example embodiment, the reactions, which correspond to the media representations, include respective emotions. The designated reaction to the task includes a designated emotion that is based on the task. Each of the emotions corresponds to a respective subset of the media representations. Each subset includes multiple media representations that represent multiple versions of the corresponding emotion. In accordance with this embodiment, the method of flowchart 700 includes selecting the designated media representation(s), which correspond to a specified version of the designated emotion, from the subset that corresponds to the designated emotion. For instance, personal assistant logic 602 may select the designated media representation(s) from the subset that corresponds to the designated emotion. In an aspect of this embodiment, the method of flowchart 700 may further include not selecting other media representations in the subset that corresponds to the designated emotion. For instance, assistant logic 602 may not select other media representations in the subset that corresponds to the designated emotion. In another aspect, the designated media representation(s) may be selected from the subset that corresponds to the designated emotion based on an amount of time since the designated media representation(s) are used being greater than an amount of time since each of the other media representations in the subset is used.

It will be recognized that device 600 may not include all of the components shown in FIG. 6. For instance, device 600 may not include one or more of personal assistant logic 602, application 604, store 606, and/or context analyzer 628. Furthermore, device 600 may include components in addition to or in lieu of personal assistant logic 602, application 604, store 606, and/or context analyzer 628.

In accordance with some example embodiments, reactions (e.g., emotions) and/or mappings of reactions to media representations may be adaptive based on a history associated with a user. For instance, the reactions and/or mappings may change as the history associated with the user changes. The history may be determined (e.g., derived, aggregated, etc.) based on interaction(s) between the user and the digital personal assistant. Accordingly, the history may correspond to a single interaction between the user and the digital personal assistant or to multiple interactions between the user and the digital assistant. An interaction includes one or more steps that are directed to performing a specified task (e.g., obtaining information about a designated subject, making a reservation at a restaurant, finding a movie theater in a designated region, determining which gas station in a designated region has the lowest prices for gas, etc.). Each step may include receipt of input (e.g., voice, touch, hover, text, or other suitable input) from the user. Information regarding such input may be incorporated into the history that is associated with the user.

For example, when an interaction includes multiple steps, information regarding each successive step may be used to determine an appropriate reaction and/or mapping to be associated with subsequent step(s) of the interaction. Accordingly, the digital personal assistant can transform to reflect a variety of reactions in a single interaction. For instance, the digital personal assistant may transform from happy to sad to serious, etc. in a single interaction.

In another example, an understanding of a user (e.g., the user's personality) may evolve over multiple interactions and/or over time. Such understanding may be used to determine appropriate reactions and/or mappings to be used by the digital personal assistant. For instance, the understanding may be used to anticipate and deliver the appropriate reactions and/or mappings in response to queries that are received from the user.

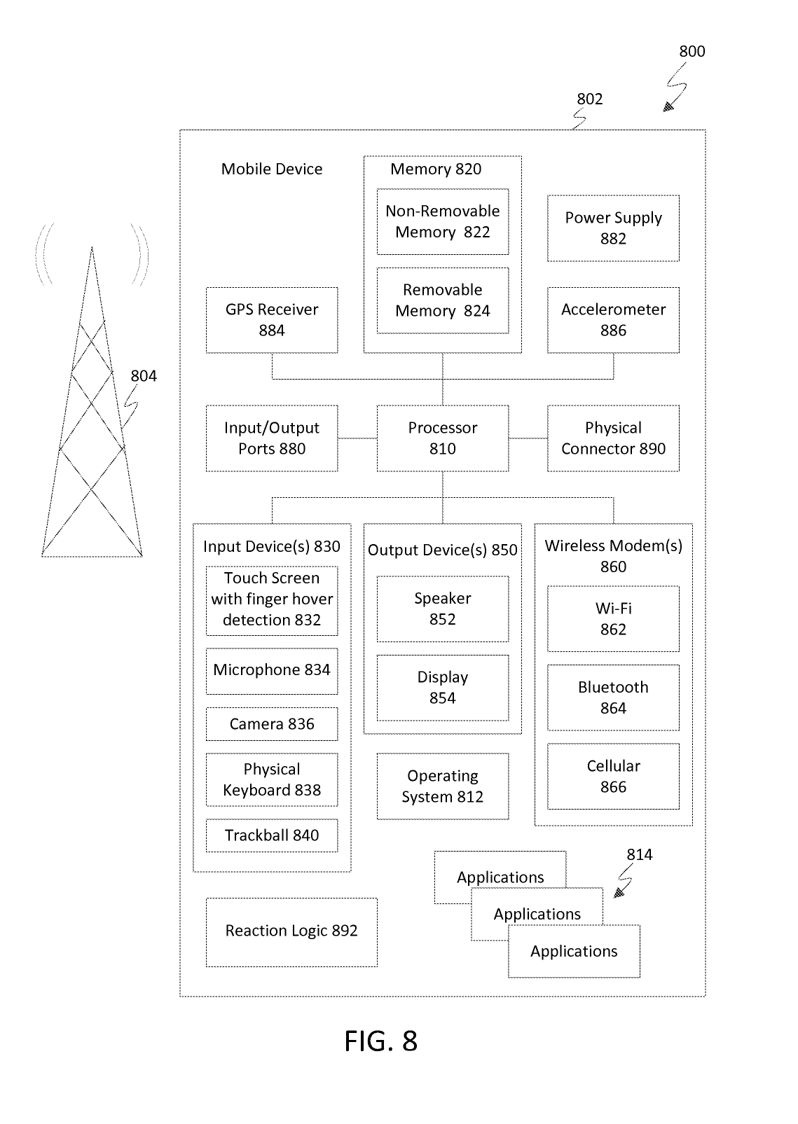

FIG. 8 is a system diagram depicting an exemplary mobile device 800 including a variety of optional hardware and software components, shown generally as 802. Any components 802 in the mobile device can communicate with any other component, though not all connections are shown, for ease of illustration. The mobile device 800 can be any of a variety of computing devices (e.g., cell phone, smartphone, handheld computer, Personal Digital Assistant (PDA), etc.) and can allow wireless two-way communications with one or more mobile communications networks 804, such as a cellular or satellite network, or with a local area or wide area network.

The illustrated mobile device 800 can include a controller or processor 810 (e.g., signal processor, microprocessor, ASIC, or other control and processing logic circuitry) for performing such tasks as signal coding, data processing, input/output processing, power control, and/or other functions. An operating system 812 can control the allocation and usage of the components 802 and support for one or more application programs 814 (a.k.a. applications). The application programs 814 can include common mobile computing applications (e.g., email applications, calendars, contact managers, web browsers, messaging applications) and any other computing applications (e.g., word processing applications, mapping applications, media player applications).

The illustrated mobile device 800 can include memory 820. Memory 820 can include non-removable memory 822 and/or removable memory 824. The non-removable memory 822 can include RAM, ROM, flash memory, a hard disk, or other well-known memory storage technologies. The removable memory 824 can include flash memory or a Subscriber Identity Module (SIM) card, which is well known in GSM communication systems, or other well-known memory storage technologies, such as “smart cards.” The memory 820 can be used for storing data and/or code for running the operating system 812 and the applications 814. Example data can include web pages, text, images, sound files, video data, or other data sets to be sent to and/or received from one or more network servers or other devices via one or more wired or wireless networks. The memory 820 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 800 can support one or more input devices 830, such as a touch screen 832, microphone 834, camera 836, physical keyboard 838 and/or trackball 840 and one or more output devices 850, such as a speaker 852 and a display 854. Touch screens, such as touch screen 832, can detect input in different ways. For example, capacitive touch screens detect touch input when an object (e.g., a fingertip) distorts or interrupts an electrical current running across the surface. As another example, touch screens can use optical sensors to detect touch input when beams from the optical sensors are interrupted. Physical contact with the surface of the screen is not necessary for input to be detected by some touch screens. For example, the touch screen 832 can support a finger hover detection using capacitive sensing, as is well understood in the art. Other detection techniques can be used, including camera-based detection and ultrasonic-based detection. To implement a finger hover, a user's finger is typically within a predetermined spaced distance above the touch screen, such as between 0.1 to 0.25 inches, or between 0.0.25 inches and 0.05 inches, or between 0.0.5 inches and 0.75 inches or between 0.75 inches and 1 inch, or between 1 inch and 1.5 inches, etc.

The mobile device 800 can include reaction logic 892. The reaction logic 892 is configured to provide a reactive digital personal assistant via output device(s) 850 in accordance with any one or more of the techniques described herein.

Other possible output devices (not shown) can include piezoelectric or other haptic output devices. Some devices can serve more than one input/output function. For example, touch screen 832 and display 854 can be combined in a single input/output device. The input devices 830 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 812 or applications 814 can comprise speech-recognition software as part of a voice control interface that allows a user to operate the device 800 via voice commands. Further, the device 800 can comprise input devices and software that allows for user interaction via a user's spatial gestures, such as detecting and interpreting gestures to provide input to a gaming application.

Wireless modem(s) 860 can be coupled to antenna(s) (not shown) and can support two-way communications between the processor 810 and external devices, as is well understood in the art. The modem(s) 860 are shown generically and can include a cellular modem 866 for communicating with the mobile communication network 804 and/or other radio-based modems (e.g., Bluetooth 864 and/or Wi-Fi 862). At least one of the wireless modem(s) 860 is typically configured for communication with one or more cellular networks, such as a GSM network for data and voice communications within a single cellular network, between cellular networks, or between the mobile device and a public switched telephone network (PSTN).

The mobile device can further include at least one input/output port 880, a power supply 882, a satellite navigation system receiver 884, such as a Global Positioning System (GPS) receiver, an accelerometer 886, and/or a physical connector 890, which can be a USB port, IEEE 1394 (FireWire) port, and/or RS-232 port. The illustrated components 802 are not required or all-inclusive, as any components can be deleted and other components can be added as would be recognized by one skilled in the art.

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

Any one or more of reaction logic 112A-112N, Web service logic 110, personal assistant logic 202, personal assistant logic 402, personal assistant logic 602, context analyzer 628, flowchart 300, flowchart 500, and/or flowchart 700 may be implemented in hardware, software, firmware, or any combination thereof.

For example, any one or more of reaction logic 112A-112N, Web service logic 110, personal assistant logic 202, personal assistant logic 402, personal assistant logic 602, context analyzer 628, flowchart 300, flowchart 500, and/or flowchart 700 may be implemented as computer program code configured to be executed in one or more processors.

In another example, any one or more of reaction logic 112A-112N, Web service logic 110, personal assistant logic 202, personal assistant logic 402, personal assistant logic 602, context analyzer 628, flowchart 300, flowchart 500, and/or flowchart 700 may be implemented as hardware logic/electrical circuitry.

For instance, in an embodiment, one or more of reaction logic 112A-112N,

Web service logic 110, personal assistant logic 202, personal assistant logic 402, personal assistant logic 602, context analyzer 628, flowchart 300, flowchart 500, and/or flowchart 700 may be implemented in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### III. EXAMPLE COMPUTER SYSTEM

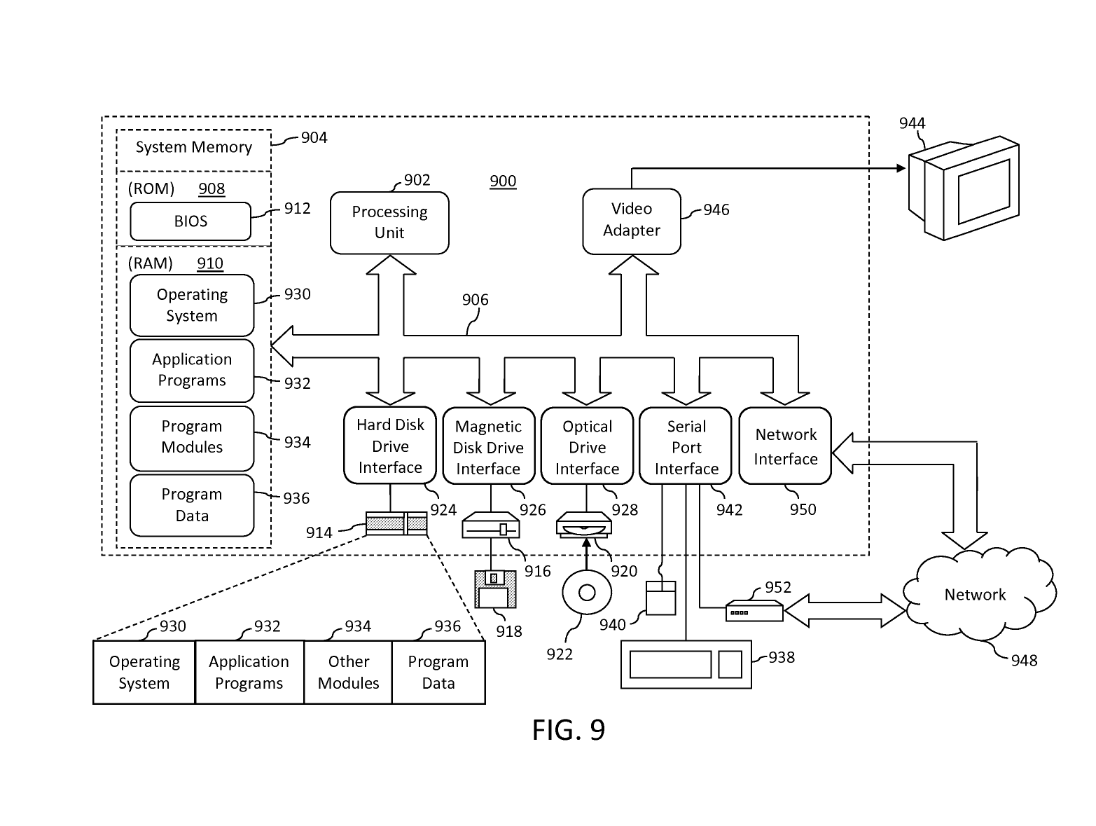

FIG. 9 depicts an example computer 900 in which embodiments may be implemented. For instance, any of devices 106A-106N and/or server(s) 102 shown in FIG. 1 may be implemented using computer 900, including one or more features of computer 900 and/or alternative features. Computer 900 may be a general-purpose computing device in the form of a conventional personal computer, a mobile computer, or a workstation, for example, or computer 900 may be a special purpose computing device. The description of computer 900 provided herein is provided for purposes of illustration, and is not intended to be limiting. Embodiments may be implemented in further types of computer systems, as would be known to persons skilled in the relevant art(s).

As shown in FIG. 9, computer 900 includes a processing unit 902, a system memory 904, and a bus 906 that couples various system components including system memory 904 to processing unit 902. Bus 906 represents one or more of any of several types of bus structures, including a memory bus or memory controller, a peripheral bus, an accelerated graphics port, and a processor or local bus using any of a variety of bus architectures. System memory 904 includes read only memory (ROM) 908 and random access memory (RAM) 910. A basic input/output system 912 (BIOS) is stored in ROM 908.

Computer 900 also has one or more of the following drives: a hard disk drive 914 for reading from and writing to a hard disk, a magnetic disk drive 916 for reading from or writing to a removable magnetic disk 918, and an optical disk drive 920 for reading from or writing to a removable optical disk 922 such as a CD ROM, DVD ROM, or other optical media. Hard disk drive 914, magnetic disk drive 916, and optical disk drive 920 are connected to bus 906 by a hard disk drive interface 924, a magnetic disk drive interface 926, and an optical drive interface 928, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 930, one or more application programs 932, other program modules 934, and program data 936. Application programs 932 or program modules 934 may include, for example, computer program logic for implementing any one or more of reaction logic 112A-112N, any one or more of digital personal assistants 116A-116N, Web service logic 110, Web service 114, personal assistant logic 202, application 204, digital personal assistant 216, personal assistant logic 402, application 404, digital personal assistant 416, personal assistant logic 602, application 604, digital personal assistant 616, context analyzer 628, flowchart 300 (including any step of flowchart 300), flowchart 500 (including any step of flowchart 500), and/or flowchart 700 (including any step of flowchart 700), as described herein.

A user may enter commands and information into the computer 900 through input devices such as keyboard 938 and pointing device 940. Other input devices (not shown) may include a microphone, joystick, game pad, satellite dish, scanner, touch screen, camera, accelerometer, gyroscope, or the like. These and other input devices are often connected to the processing unit 902 through a serial port interface 942 that is coupled to bus 906, but may be connected by other interfaces, such as a parallel port, game port, or a universal serial bus (USB).

A display device 944 (e.g., a monitor) is also connected to bus 906 via an interface, such as a video adapter 946. In addition to display device 944, computer 900 may include other peripheral output devices (not shown) such as speakers and printers.

Computer 900 is connected to a network 948 (e.g., the Internet) through a network interface or adapter 950, a modem 952, or other means for establishing communications over the network. Modem 952, which may be internal or external, is connected to bus 906 via serial port interface 942.

As used herein, the terms “computer program medium” and “computer-readable storage medium” are used to generally refer to media such as the hard disk associated with hard disk drive 914, removable magnetic disk 918, removable optical disk 922, as well as other media such as flash memory cards, digital video disks, random access memories (RAMs), read only memories (ROM), and the like. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media.

As noted above, computer programs and modules (including application programs 932 and other program modules 934) may be stored on the hard disk, magnetic disk, optical disk, ROM, or RAM. Such computer programs may also be received via network interface 950 or serial port interface 942. Such computer programs, when executed or loaded by an application, enable computer 900 to implement features of embodiments discussed herein. Accordingly, such computer programs represent controllers of the computer 900.

Example embodiments are also directed to computer program products comprising software (e.g., computer-readable instructions) stored on any computer-useable medium. Such software, when executed in one or more data processing devices, causes data processing device(s) to operate as described herein. Embodiments may employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

It will be recognized that the disclosed technology is not limited to any particular computer or type of hardware. Certain details of suitable computers and hardware are well known and need not be set forth in detail in this disclosure.

### IV. CONCLUSION

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described example embodiments, but should be defined only in accordance with the following claims and their equivalents.

What is claimed is:

1. A device comprising:
an application configured to provide an emotion request that requests for a digital personal assistant to have a designated emotion;
a store configured to store a plurality of media representations that correspond to a plurality of emotions, the plurality of emotions including the designated emotion; and
personal assistant logic configured to select at least one designated media representation from the plurality of media representations in response to the emotion request based on the at least one designated media representation corresponding to the designated emotion, the personal assistant logic further configured to use the at least one designated media representation to provide the digital personal assistant having the designated emotion.

2. The device of claim 1, wherein the personal assistant logic is further configured to notify the application of a status of the digital personal assistant, the status indicating that the digital personal assistant is configured to have the designated emotion.

3. The device of claim 1, wherein the application is further configured to provide a query for content to a Web service via a network;
wherein the application is configured to provide the emotion request in response to receipt of an emotion indicator that specifies the designated emotion from the Web service via the network; and
wherein the designated emotion is based on the content.

4. The device of claim 3, wherein the personal assistant logic is further configured to use the at least one designated media representation to change a form of the digital personal assistant from a first form to a second form, the second form based on the content.

5. The device of claim 3, wherein the personal assistant logic is further configured to use the at least one designated media representation to cause the digital personal assistant to interact with the content.

6. The device of claim 3, further comprising a user interface;
wherein the application is configured to receive the content from the Web service via the network; and
wherein the personal assistant logic is configured to change an emotion of the digital personal assistant from a first emotion to the designated emotion in response to presentation of the content via the user interface.

7. The device of claim 3, further comprising a user interface;
wherein the application is configured to receive the content from the Web service via the network; and
wherein the personal assistant logic is further configured to use the at least one designated media representation to cause the digital personal assistant to provide a hint of the content before the content is presented via the user interface.

8. The device of claim 1, wherein the application is further configured to select the designated emotion from the plurality of emotions based on a task that is performed by a user with respect to the application.

9. The device of claim 1, wherein each emotion of the plurality of emotions corresponds to a respective subset of the plurality of media representations, each subset including multiple media representations that represent multiple versions of the corresponding emotion; and
wherein the personal assistant logic is configured to select the at least one designated media representation, which corresponds to a specified version of the designated emotion, from the subset that corresponds to the designated emotion.

10. A computer program product comprising a computer-readable medium having computer program logic recorded thereon for enabling a processor-based system to provide a digital personal assistant having a reaction to content, the computer program logic comprising:
a first program logic module for enabling the processor-based system to provide a query for the content from an application that executes on the processor-based system to a Web service via a network;
a second program logic module for enabling the processor-based system to provide a use request from the application in response to receipt of at least one designated media representation from the Web service via the network, the use request requesting for the at least one designated media representation to be used to provide the digital personal assistant, the at least one designated media representation defining the reaction to the content; and
a third program logic module for enabling the processor-based system to use the at least one designated media representation to provide the digital personal assistant having the reaction to the content in response to receipt of the use request.

11. The computer program product of claim 10, wherein the third program logic module includes logic for enabling the processor-based system to stop using at least one first media representation to provide the digital personal assistant and start using the at least one designated media representation to provide the digital personal assistant having the reaction to the content in response to presentation of the content, which is received by the application from the Web service via the network, via a user interface of the processor-based system.

12. The computer program product of claim 10, wherein the third program logic module includes logic for enabling the processor-based system to use the at least one designated media representation to cause the digital personal assistant to provide a hint of the content, which is received by the application from the Web service via the network, before the content is presented via the processor-based system.

13. The computer program product of claim 10, wherein the content includes at least one of search results or search suggestions.

14. The computer program product of claim 10, wherein the third program logic module includes logic for enabling the processor-based system to use the at least one designated media representation to change a form of the digital personal assistant from a first form to a second form, the second form based on the content.

15. The computer program product of claim 10, wherein the third program logic module includes logic for enabling the processor-based system to use the at least one designated media representation to cause the digital personal assistant to interact with the content.

16. In a device having one or more processors and a store, a method comprising:
providing, by an application that executes on at least one of the one or more processors, a task indicator that specifies a task that is at least initiated by a user with respect to the application;
storing a plurality of media representations that correspond to a plurality of reactions by the store;
providing a context request that requests a context of the user in response to receipt of the task indicator;
receiving a context indicator that specifies the context of the user in response to providing the context request;
selecting at least one designated media representation from the plurality of media representations in response to receipt of the context indicator based on a designated reaction that corresponds to the at least one designated media representation being associated with the context of the user and the task; and
using the at least one designated media representation to provide a digital personal assistant having the designated reaction to the task, the designated reaction being included in the plurality of reactions.

17. The method of claim 16, further comprising:
notifying the application of a status of the digital personal assistant, the status indicating that the digital personal assistant is configured to have the designated reaction.

18. The method of claim 16, wherein the context of the user includes an emotional state of the user.

19. The method of claim 16, wherein the plurality of reactions includes a plurality of respective emotions;
wherein the designated reaction to the task includes a designated emotion that is based on the task;
wherein each emotion of the plurality of emotions corresponds to a respective subset of the plurality of media representations, each subset including multiple media representations that represent multiple versions of the corresponding emotion; and
wherein the method further comprises:
selecting the at least one designated media representation, which corresponds to a specified version of the designated emotion, from the subset that corresponds to the designated emotion.

20. The method of claim 16, wherein using the at least one designated media representation comprises:
using the at least one designated media representation to transform the digital personal assistant into a control that is usable by the user to complete the task.
